(19) United States
(12) Patent Application Publication
(10) Pub. No.: US 2020/0056753 A1
(43) Pub. Date: Feb. 20, 2020

(54) Smart Street Lamp

(71) Applicant: IPSecures Corporation, Taipei City (TW)

(72) Inventor: HUNG-HSIANG CHIANG, Taipei City (TW)

(21) Appl. No.: 16/544,855

(22) Filed: Aug. 19, 2019

(30) Foreign Application Priority Data
Aug. 20, 2018 (TW) 107129020

(51) Int. Cl. F21S 8/08; F21V 23/00; F21V 31/00

(52) U.S. Cl. CPC F21S 8/086; F21W 2111/02; F21V 31/005; F21V 23/002

(57) ABSTRACT

A smart street lamp is provided. By a structural design of a device erection seat having the same form, a smart street lamp can not only be used for disposing different types of electronic devices, but also unify installation specifications of electronic devices disposed on a street lamp, so as to achieve the purpose of city beautification. It also facilitates subsequent unified maintenance management for these electronic devices, so that labor cost can be saved effectively.

### CROSS-REFERENCE TO RELATED APPLICATIONS

This application claims the priority of Republic of China Patent Application No. 107129020 filed on Aug. 20, 2018, in the State Intellectual Property Office of the R.O.C., the disclosure of which is incorporated herein by reference.

### BACKGROUND OF THE INVENTION

### Field of the Invention

The present invention relates to a smart street lamp, and more particularly, to a smart street lamp that integrates electronic devices.

### Descriptions of the Related Art

With continuous development of network technology, the application level of urban informatization has been improved continuously, and the construction of smart cities has emerged. The construction of smart cities must have relevant smart devices popularized and laid. Therefore, in the public areas of smart cities, smart devices are laid everywhere, such as various surveillance cameras used for urban security management or traffic supervision, various environmental detectors used for monitoring the quality of urban environment etc.

However, installation methods for these smart devices are disorganized mostly today, some of which are installed as independent poles directly and thus disturb original road construction plans, as well as some of which are hung on poles of street lamps directly and thus destroy the cleanliness of original cityscape. Moreover, such disordered installation methods not only impose great security risks, but also increase the cost of daily operation and maintenance.

Therefore, how to unify installation specifications of smart devices is a technical subject to be solved by the present invention.

### SUMMARY OF THE INVENTION

In view of the above-mentioned shortcomings of the prior art, a smart street lamp is provided in the present invention for disposing different types of electronic devices, and unify installation specifications of electronic devices for city beautification, and facilitates to the technical effects of operation, maintenance and management in later stages.

According to another purpose of the invention, a smart street lamp is provided in the present invention for sensing the state of a base body for receiving built-in devices, and prevent the built-in devices from being damaged effectively.

To achieve the above and other objects, a smart street lamp is provided in a first embodiment of the present invention, for erecting a first external device, a second external device or a shielding structure. The smart street lamp includes: a running cable; a street lamp body to be fixed at a road surface; a lamp bracket coupled removably to a top of the street lamp body and having at least one luminaire for providing illumination; a first external device carrier carrying the first external device; a second external device carrier carrying the second external device; and a plurality of device erection seats, each of which has the same form, and has a welding portion and an erection seat body, a shape of the welding portion matching a contour of the street lamp body or the lamp bracket in order for fixing the erection seat body at the street lamp body or the lamp bracket by means of welding, the erection seat body having a penetration space, at least one of the plurality of device erection seats can be optionally engaged with the first external device carrier for the running cable to connect the first external device via the penetration space in order to erect the first external device at the street lamp body or the lamp bracket, and provide running of the first external device through the running cable, alternatively, at least one of the plurality of device erection seats can be optionally engaged with the second external device carrier, so that the running cable connects the second external device via the penetration space, in order for erecting the second external device at the street lamp body or the lamp bracket, and providing running of the second external device through the running cable, or at least one of the plurality of device erection seats can be optionally engaged with the shielding structure, in order for shielding the penetration space by the shielding structure.

Furthermore, a smart street lamp is provided in a second embodiment of the present invention, used to engage a first external device carrier or a shielding structure for erecting a first external device carried at the first external device carrier. The smart street lamp includes: a street lamp body to be fixed at a road surface; a lamp bracket coupled removably to a top of the street lamp body and having at least one luminaire for providing illumination; and a plurality of device erection seats, each of which has the same form, and has a welding portion and an erection seat body, a shape of the welding portion matching a contour of the street lamp body or the lamp bracket in order for fixing the erection seat body at the street lamp body or the lamp bracket by means of welding, at least one of the plurality of device erection seats can be optionally engaged with the first external device carrier in order to erect the first external device at the street lamp body or the lamp bracket, alternatively, at least one of the plurality of device erection seats can be optionally engaged with the shielding structure, in order for shielding the penetration space by the shielding structure.

Preferably, the smart street lamp said above further includes a running cable, and the erection seat body having a penetration space and a drain passage; wherein the running cable connects the first external device via the penetration space in order to provide running of the first external device; the drain passage extends to the penetration space in order to discharge excess liquid in the penetration space.

Preferably, the smart street lamp said above further includes a flange, the flange accomplishing coupling between the lamp bracket and the street lamp body by means of screwing; the shape of the welding portion being a circular arc shape.

Preferably, the smart street lamp said above, wherein the device erection seat further has an erection seat top eave disposed at a top of the erection seat body and extending outwardly, in order to block the liquid from entering the penetration space outside the erection seat body, the erection seat body and the erection seat top eave form a house structure having an eave, the erection seat top eave being the eave.

Preferably, the smart street lamp said above, wherein the erection seat body further has a seat body front panel and at least one seat body side panel, the seat body front panel and the at least one seat body side panel intersecting the erection seat top eave, the first external device carrier having a first carrier front panel and at least one first carrier side panel; wherein as the first external device carrier engages the device erection seat, the first carrier front plate and the at least one first carrier side plate facing directly the seat body front panel and the at least one seat body side panel, respectively.

Preferably, the smart street lamp said above, wherein a side panel external device can be erected further, the smart street lamp further including: a side panel external device carrier disposed at the at least one seat body side panel or the first carrier side panel for erecting the side panel external device.

Preferably, the smart street lamp said above, wherein the at least one first carrier side panel is two first carrier side panels, such that the first external device carrier has a U-shaped cross section.

Preferably, the smart street lamp said above, wherein the erection seat body further has a seat body bottom panel located below the erection seat top eave, and the seat body bottom panel intersects the seat body front panel or the at least one seat body side panel, the drain passage being disposed at an intersection of the seat body bottom panel and the seat body front panel or the at least one seat body side panel.

Preferably, the smart street lamp said above, wherein the device erection seat further has a hanging structure disposed at the seat body front panel or the erection seat top eave, in order for the first external device carrier to be hung at the erection seat body before the first external device carrier engages the device erection seat.

Preferably, the smart street lamp said above, being further used for erecting at least one built-in device, wherein the street lamp body has a base for fixing at a road surface, and the base has a base body and a mounting rail, the mounting rail being disposed at the base body, the at least one built-in device being received in an inner space of the base body, and erected on the mounting rail in order for shifting relative to the base body by the mounting rail.

Preferably, the smart street lamp said above, wherein the base further has a door for opening/closing the inner space of the base body, and the smart street lamp further includes a door opening/closing sensing mechanism for sensing an opening/closing state of the door, and reporting a sensing result to a preset object.

Preferably, the smart street lamp said above, wherein the at least one luminaire is a plurality of luminaires.

In comparison to prior arts, the smart street lamp according to the present invention can provide erection for different types of electronic devices, and unify installation specifications of electronic devices for city beautification, and facilitate subsequent operation, maintenance and manipulation of the electronic devices, as well as improve utilization for public resources of cities. Furthermore, the smart street lamp according to the present invention can sense opening/closing state of a base body for receiving built-in devices, in order to output an abnormal sensing result as a prompt for a preset object to know as abnormal opening/closing state of the base body is sensed. Thereby, normal operations of the built-in devices in the base body are guaranteed.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1 and 2 are overall architecture schematic views showing a smart street lamp according to an embodiment of the present invention;

FIGS. 1-1 and 2-1 are overall architecture schematic views showing a smart street lamp according to another embodiment of the present invention;

FIGS. 3 to 6, 6-1, 7 and 7-1 are partial architecture schematic views showing a smart street lamp according to different embodiments of the present invention;

FIGS. 8-1 to 8-5 are partial architecture schematic views showing a first external device, second external device or side panel external device of a smart street lamp according to different embodiments of the present invention; and

FIG. 9 is partial perspective schematic views showing a base of a smart street lamp according to the present invention.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

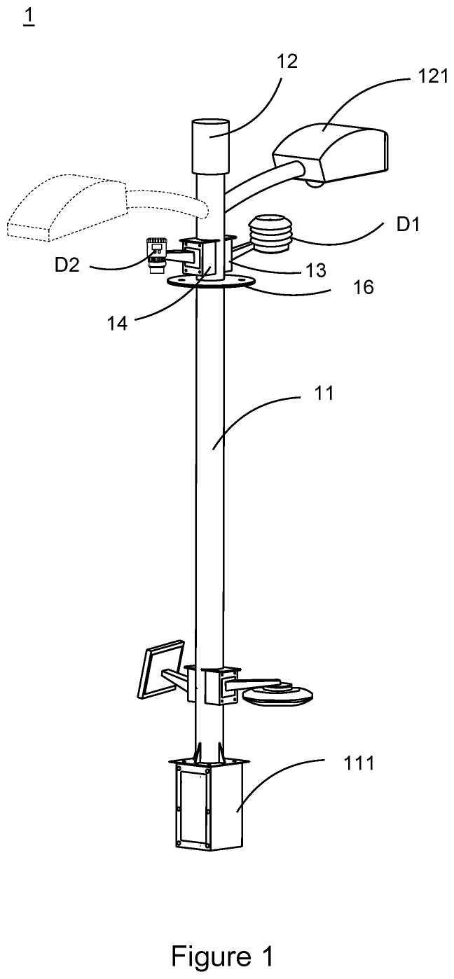

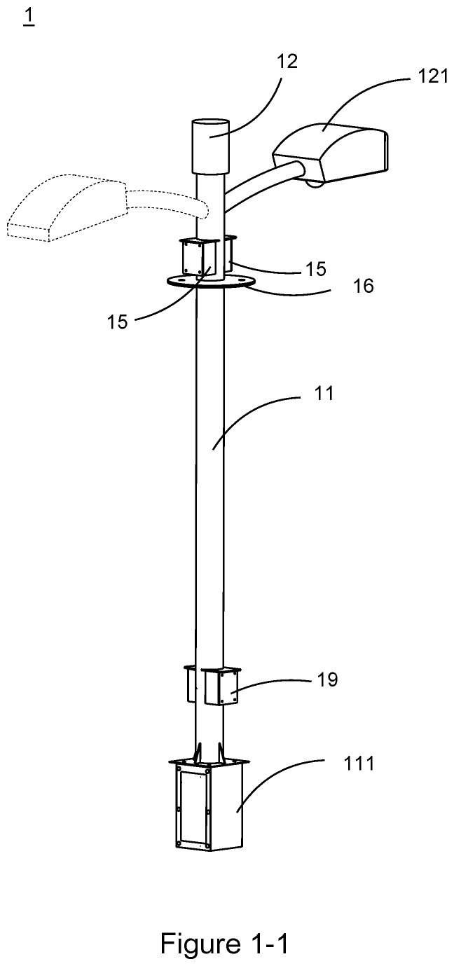

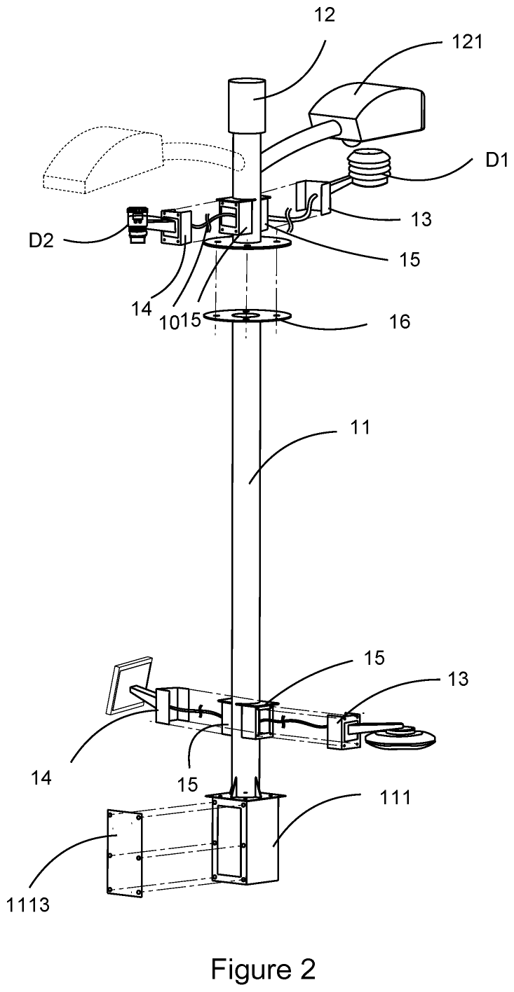

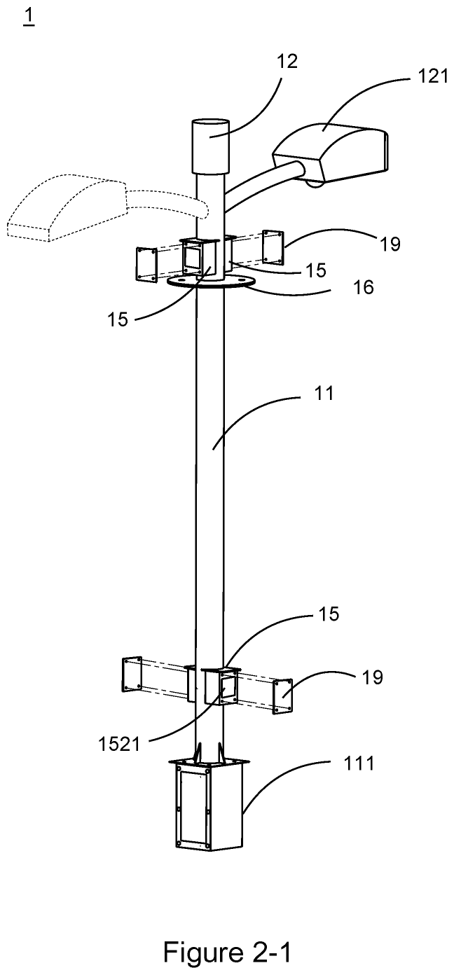

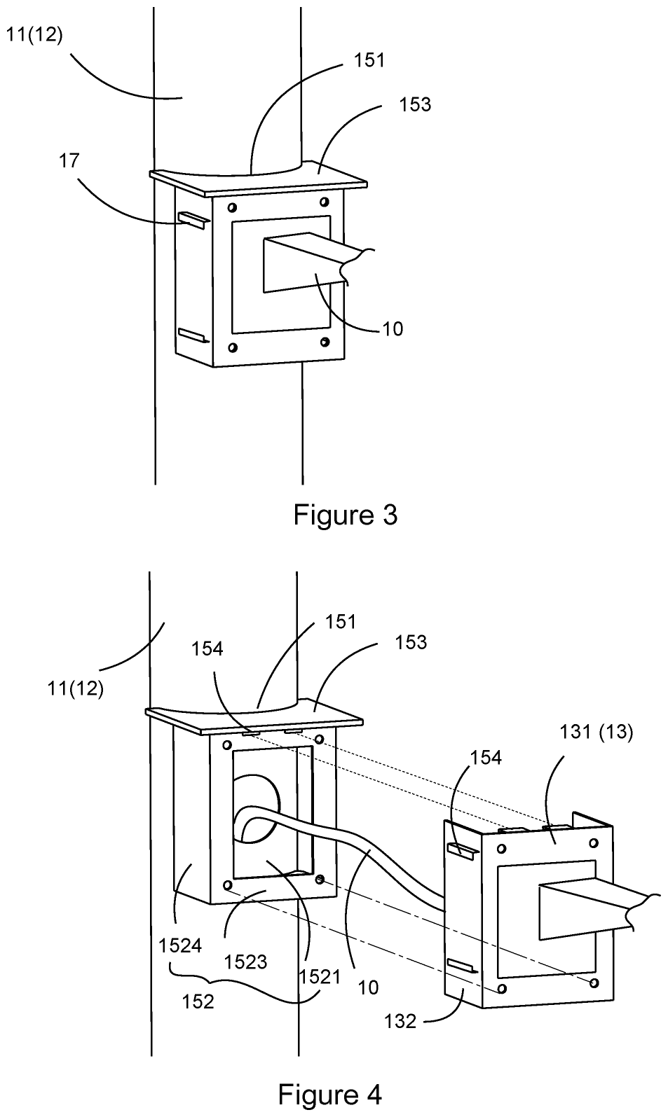

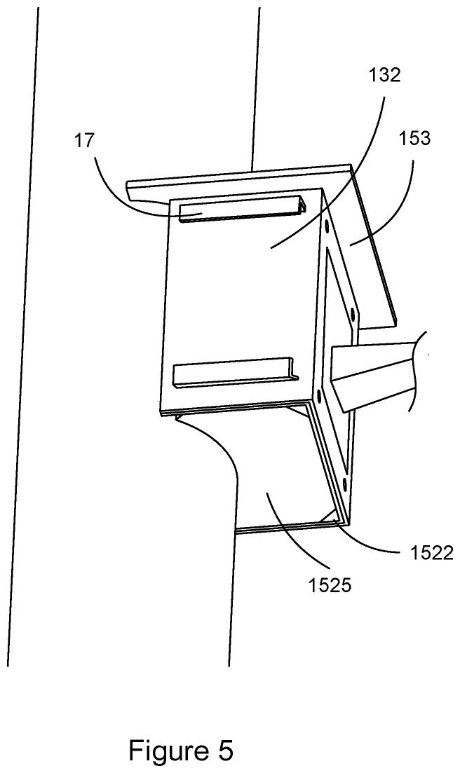

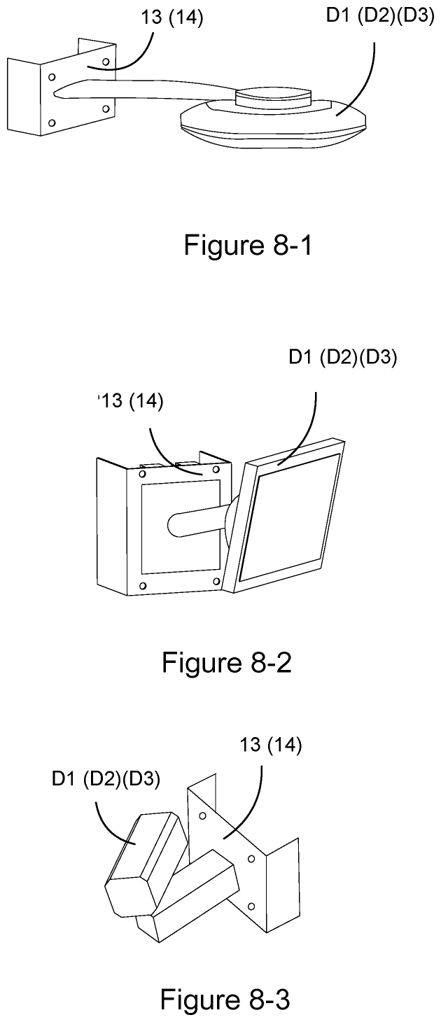

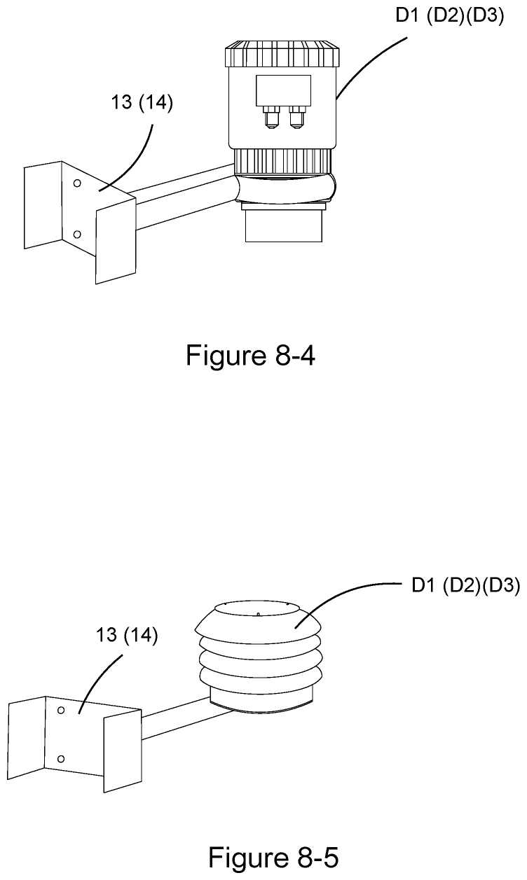

Referring to FIGS. 1, 1-1, 2 and 2-1, a smart street lamp 1 according to the present invention may be used to erect a shielding structure 19, or may be used to erect a first external device D1 or a second external device D2 with different types. In the present invention, the first, second external device D1, D2 may be a network photography device (a panoramic camera as shown in FIG. 8-1 or a gun type camera as shown in FIG. 8-3), a sensing device (a water level gauge as shown in FIG. 8-4 or an environmental sensor as shown in FIG. 8-5), a display device (a digital signage as shown in FIG. 8-2), a broadcasting device, a signaling device, a signboard device, an emergency calling device or a charging device.

The smart street lamp 1 according to the present invention has a running cable 10, a street lamp body 11, a lamp bracket 12 and a plurality of device erection seats 15. The running cable 10 is, for example, a communication cable or a power supply line. The street lamp body 11 is fixed at a road surface. The lamp bracket 12 may be provided optionally with one or more luminaires 121 that may provide illumination over a wide range, depending on actual illumination needs. Preferably, the lamp bracket 12 is coupled to the top of the street lamp body 11 removably (detachably) for replacing lamp brackets of different specifications according to actual needs to match with the street lamp body 11, and in turn, for providing different specifications or quantities of luminaires 121 to meet requirement of illumination.

The device erection seat 15 may also be used optionally with a first, second external device carrier 13, 14 for carrying the first, second external device D1, D2, respectively. Preferably, the smart street lamp 1 includes a flange 16 in order to accomplish disassembly and assembly of both the lamp bracket 12 and the street lamp body 11 by means of screwing.

In the present invention, all the plurality of device erection seats 15 have welding portions 151 with substantially the same forms and erection seat bodies 152 with substantially the same forms. As shown in FIG. 3, the welding portion 151 is matched with the outline of the street lamp body 11 or the lamp bracket 12 (for example, the welding portion may be designed to have a circular arc shape to match with existing circular street lamp poles), in order for the erection seat 152 to be fixed onto the street lamp body 11 or the lamp bracket 12 by means of welding using the welding portion without adding other coupling members.

As shown in FIGS. 4 and 5, the erection seat body 152 further has a penetration space 1521 and a drain passage 1522, while the device erection seat 15 may be engaged optionally with a shielding structure 19, in order to shield the penetration space 1521 by the shielding structure 19. The drain passage 1522 (as shown in FIG. 5) is disposed at the bottom of the penetration space 1521 for discharging liquid in the penetration space 1521, to avoid the liquid accumulated in the penetration space 1521 from influencing the running cable 10 therein or the first external device D1, which results in unexpected running for the first external device Dl.

As the device erection seat 15 is engaged with the first external device carrier 13, the running cable 10 connects the first external device D1 via the penetration space 1521 in the erection seat body 152 for erecting the first external device D1 on the street lamp body 11 or the lamp bracket 12, and providing power or signal transmission running through the running cable 10 for the first external device D1 to run. As the device erection seat 15 is engaged with the second external device carrier 14, the running cable 10 electrically connects the second external device D2 via the penetration space 1521 in the erection seat body 152, in order for erecting the second external device D2 on the street lamp body 11 or the lamp bracket 12, and providing running of second external device D2 through the running cable 10.

Therefore, in the present invention, the device erection seats 15 with the same form are provided for different types of electronic devices (i.e., the first, second external devices) erected on the street lamp body 11 or the lamp bracket 12, thereby unifying configurations between different types of electronic devices, including erections, wiring methods, and power supply specifications etc., to achieve the technical effects of city beautification and simplification for erection of electronic devices, and facilitate to perform unified operation, maintenance and management for these electronic devices in later stages.

It should be noted that descriptions for related embodiments of the second external device carrier and the second external device are omitted for simplification.

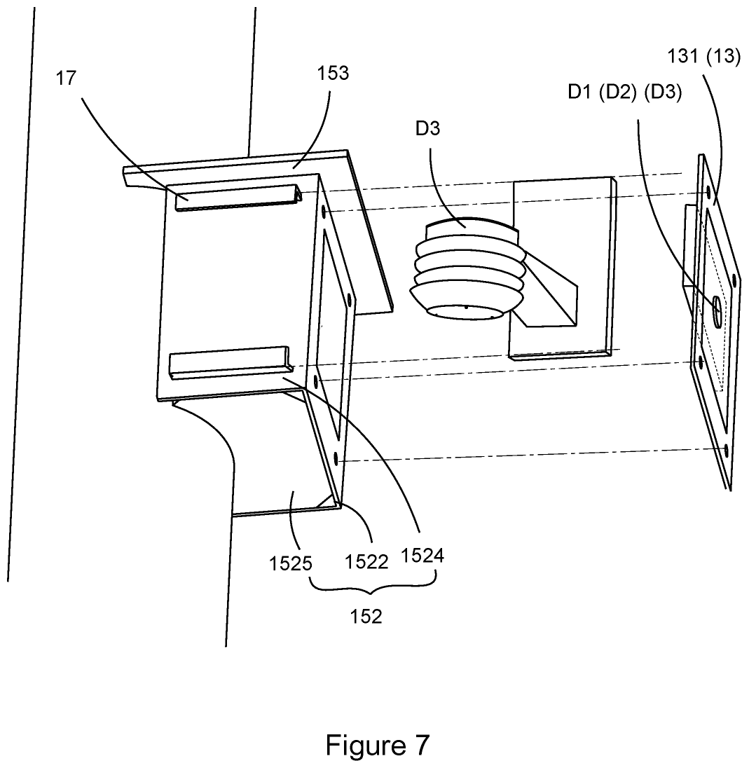

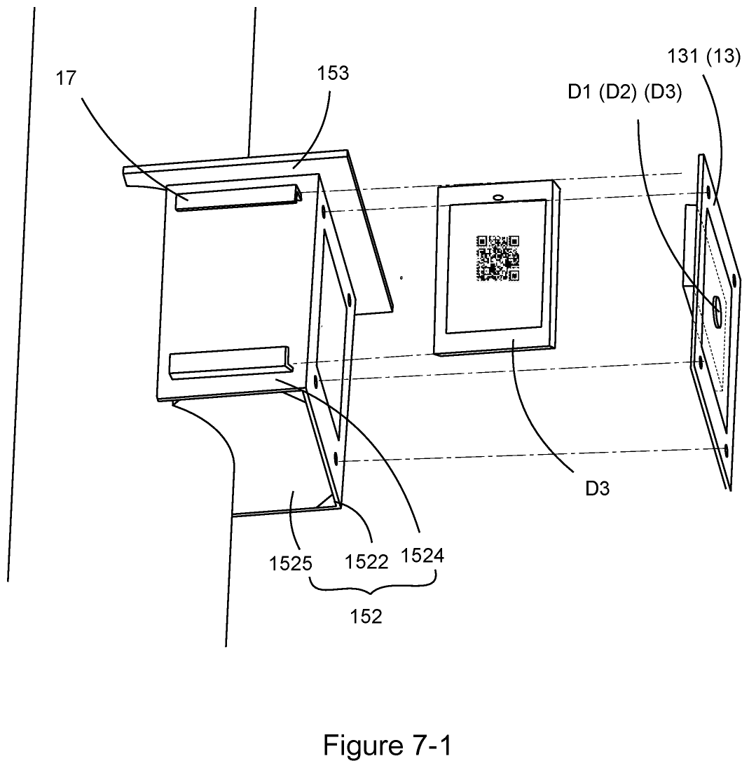

Referring to FIGS. 3-6, 6-1, 7 and 7-1, preferably, the device erection seat 15 further has an erection seat top eave 153 disposed at the top of the erection seat body 152 and extending outwardly, the erection seat body 152 and the erection seat top eave 153 form a house structure, and the erection seat top eave 153 is an eave of the house structure, in order to block liquid from entering the interior of the penetration space at the top of the erection seat body, thereby preventing effectively the liquid, such as rainwater, from entering the penetration space 1521, which influences the running cable 10, and in turn, results abnormal running of the first external device D1 connected to the running cable 10.

Preferably, the erection seat body 152 includes a seat body front panel 1523 and a seat body side panel 1524 that intersect the erection seat top eave 153, respectively. Correspondingly, the first external device carrier 13 includes a first carrier front panel 131 and a first carrier side panel 132. As the first external device carrier 13 is engaged to the device erection seat 15, the first carrier front panel and the first carrier side panel face directly the seat body front panel 1523 and the seat body side panel 1524 of the erection seat body 152, respectively. In the embodiment shown in FIG. 4, the first external device carrier 13 is provided with, for example, two first carrier side panels 132, for the first external device carrier 13 to have a U-shaped cross section, such that the first external device carrier 13 may block external liquid from entering the penetration space 1521 of the erection seat body 152 on the front and on the left and right sides at the same time by using a structural design of the seat body front panel 1523 and the seat body side panel 1524, so as to avoid effectively existence of liquid in the erection seat body 152, which influences the use.

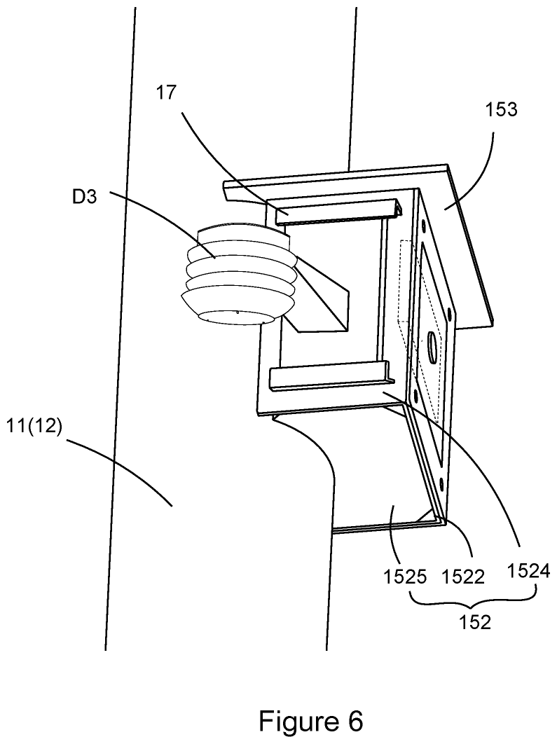

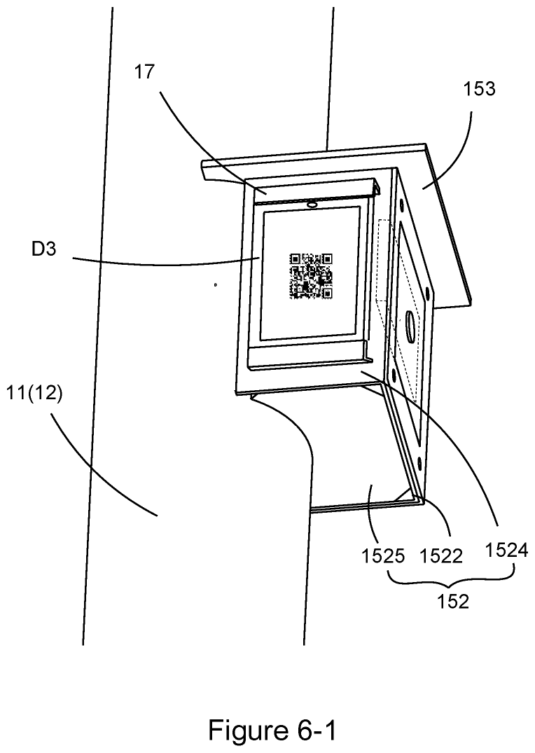

In the embodiment as shown in FIGS. 5 and 6, the erection seat body 152 is provided with a seat body bottom panel 1525 intersecting with the seat body front panel 1521 or the seat body side panel 1524 below the erection seat top eave 153, while the drain passage 1522 may be disposed at an intersection of the seat body bottom panel 1525 and the seat body front panel 1521 or the seat body side panel 1522, to avoid the seat body bottom panel 1525 from hole breaking, which influences the structural strength of the erection seat body 152.

Preferably, as shown in FIG. 3 and FIGS. 5, 6, 6-1, 7 and 7-1, the smart street lamp 1 is provided with a side panel external device carrier 17 on the seat body side panel 1524 or the first carrier side panel 132 for erecting a side panel external device D3 that may provide external services through display of images by a display device as shown in FIGS. 6-1 and 7-1. Therefore, by the structural design of the side panel external device carrier 17, the number of disposed external devices may be increased to improve the utilization of the smart street lamp 1. In the present invention, the side panel external device D3 may be a network photography device (a panoramic camera as shown in FIG. 8-1 or a gun type camera as shown in FIG. 8-3), a sensing device (a water level gauge as shown in FIG. 8-4 or an environmental sensor as shown in FIG. 8-5), a display device (a digital signage as shown in FIG. 8-2), a broadcasting device, a signaling device, a signboard device, an emergency calling device or a charging device.

Preferably, as shown in FIG. 4, the device erection seat 15 is provided with a hanging structure 154 on the seat body front panel 1523 or the erection seat top eave 153, in order to hang the first external device carrier 13 at the erection seat body 152 before the first external device carrier 13 is engaged onto the device erection seat 15. Accordingly, it prevents the first external device carrier 13 from falling onto the ground. Even more, it allows mutual alignment between the first external device carrier 13 and the erection seat body 152 conveniently to facilitate engagement of the first external device carrier 13 to the device erection seat 15.

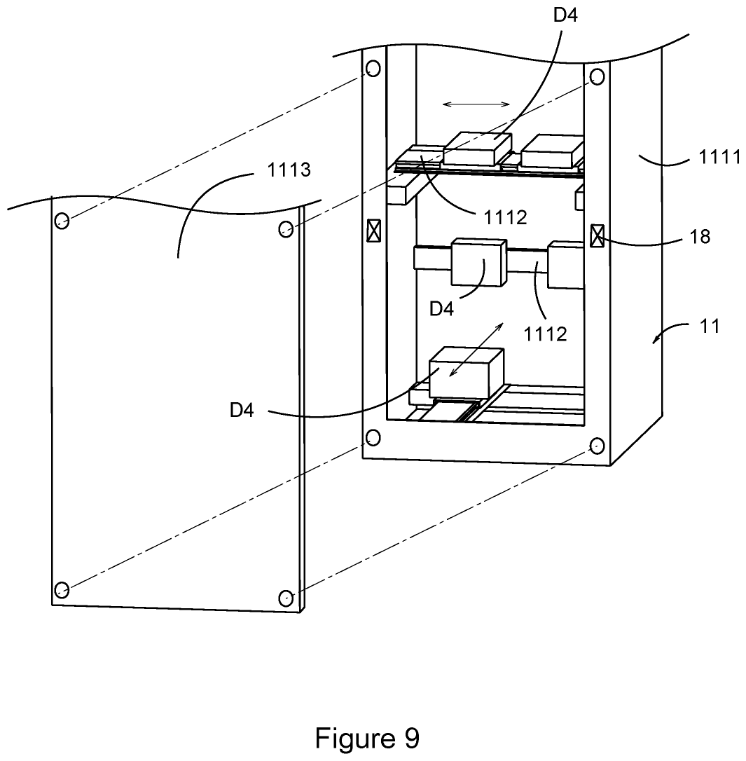

Preferably, continuing to refer to FIG. 9, the street lamp body 11 has a base 111 for fixing at the road surface. The base 111 includes a base body 1111 and a mounting rail 1112 disposed in the base body 1111. The mounting rail 1112 may be erected with a built-in device D4, in order for the built-in device D4 to be capable of being shifted relative to the base body 1111 by the mounting rail 1112 for shifting the built-in device D4 to an appropriate position (for example, a position for better communication signals or a position for easy wiring) in the base body 1111, such that it achieves the purpose of properly utilizing the internal space of the base body 1111, and can also facilitate signal transmission operation of the built-in device D4. The built-in device D4 is, for example, a power distribution device, a switch device, a network router device, a wireless access device, a fiber optic device, a bypass device or a light control device.

Preferably, the base 111 has a door for opening/closing the inner space of the base body 1111. Correspondingly, the smart street lamp 1 includes a door opening/closing sensing mechanism 18 to sense the opening/closing state of the door and report the sensing result to a predetermined object, and thus monitor exception for the opening state of the door. Moreover, as illegal opening of the door is detected, an alert signal is output automatically and sent to a relevant person to know, so as to achieve effective protection of the effect for the built-in device D4 disposed in the base body 1111 for preventing the door from illegal opening, which causes the built-in device D4 disposed in the base body to be damaged or stolen.

In summary, a smart street lamp is provided. By a structural design of a device erection seat having the same form, a smart street lamp can not only be used for disposing different types of electronic devices, but also unify installation specifications of electronic devices disposed on a street lamp, so as to achieve the purpose of city beautification. It also facilitates subsequent unified maintenance management for these electronic devices, so that labor cost can be saved effectively.

Furthermore, the smart street lamp according to the present invention may sense whether an accommodation space for arranging electronic devices on the street lamp is invaded illegally by the design of the door opening/closing sensing mechanism, thereby preventing effectively the electronic devices from being damaged, and facilitating normal operation of the electronic devices.

The examples above are only illustrative to explain principles and effects of the invention, but not to limit the invention. It will be apparent to those skilled in the art that modifications and variations can be made without departing from the scope of the invention. Therefore, the protection range of the rights of the invention should be as defined by the appended claims.

What is claimed is:

1. A smart street lamp for erecting a first external device, a second external device or a shielding structure, the smart street lamp including:
a running cable;
a street lamp body to be fixed at a road surface;
a lamp bracket coupled removably to a top of the street lamp body and having at least one luminaire for providing illumination;
a first external device carrier carrying the first external device;
a second external device carrier carrying the second external device; and
a plurality of device erection seats, each of which has the same form, and has a welding portion and an erection seat body, a shape of the welding portion matching a contour of the street lamp body or the lamp bracket in order for fixing the erection seat body at the street lamp body or the lamp bracket by means of welding, the erection seat body having a penetration space, at least one of the plurality of device erection seats can be optionally engaged with the first external device carrier for the running cable to connect the first external device via the penetration space in order to erect the first external device at the street lamp body or the lamp bracket, and provide running of the first external device through the running cable, alternatively, at least one of the plurality of device erection seats can be optionally engaged with the second external device carrier, so that the running cable connects the second external device via the penetration space, in order for erecting the second external device at the street lamp body or the lamp bracket, and providing running of the second external device through the running cable, alternatively, at least one of the plurality of device erection seats can be optionally engaged with the shielding structure, in order for shielding the penetration space by the shielding structure.

2. A smart street lamp used to engage a first external device carrier or a shielding structure for erecting a first external device carried at the first external device carrier, the smart street lamp including:
a street lamp body to be fixed at a road surface;
a lamp bracket coupled removably to a top of the street lamp body and having at least one luminaire for providing illumination; and
a plurality of device erection seats, each of which has the same form, and has a welding portion and an erection seat body, a shape of the welding portion matching a contour of the street lamp body or the lamp bracket in order for fixing the erection seat body at the street lamp body or the lamp bracket by means of welding, at least one of the plurality of device erection seats can be optionally engaged with the first external device carrier in order to erect the first external device at the street lamp body or the lamp bracket, alternatively, at least one of the plurality of device erection seats can be optionally engaged with the shielding structure, in order for shielding the penetration space by the shielding structure.

3. The smart street lamp of claim 2, further including a running cable, and the erection seat body having a penetration space and a drain passage; wherein
the running cable connects the first external device via the penetration space in order to provide running of the first external device;
the drain passage extends to the penetration space in order to discharge excess liquid in the penetration space.

4. The smart street lamp of claim 3, further including a flange, the flange accomplishing coupling between the lamp bracket and the street lamp body by means of screwing; the shape of the welding portion being a circular arc shape.

5. The smart street lamp of claim 3, wherein the device erection seat further has an erection seat top eave disposed at a top of the erection seat body and extending outwardly, in order to block the liquid from entering the penetration space outside the erection seat body, the erection seat body and the erection seat top eave form a house structure having an eave, the erection seat top eave being the eave.

6. The smart street lamp of claim 5, wherein the erection seat body further has a seat body front panel and at least one seat body side panel, the seat body front panel and the at least one seat body side panel intersecting the erection seat top eave, the first external device carrier having a first carrier front panel and at least one first carrier side panel; wherein
as the first external device carrier engages the device erection seat, the first carrier front plate and the at least one first carrier side plate facing directly the seat body front panel and the at least one seat body side panel, respectively.

7. The smart street lamp of claim 6, wherein a side panel external device can be erected further, the smart street lamp further including:
a side panel external device carrier disposed at the at least one seat body side panel or the first carrier side panel for erecting the side panel external device.

8. The smart street lamp of claim 6, wherein the at least one first carrier side panel is two first carrier side panels, such that the first external device carrier has a U-shaped cross section.

9. The smart street lamp of claim 6, wherein the erection seat body further has a seat body bottom panel located below the erection seat top eave, and the seat body bottom panel intersects the seat body front panel or the at least one seat body side panel, the drain passage being disposed at an intersection of the seat body bottom panel and the seat body front panel or the at least one seat body side panel.

10. The smart street lamp of claim 6, wherein the device erection seat further has a hanging structure disposed at the seat body front panel or the erection seat top eave, in order for the first external device carrier to be hung at the erection seat body before the first external device carrier engages the device erection seat.

11. The smart street lamp of claim 2, being further used for erecting at least one built-in device, wherein the street lamp body has a base for fixing at a road surface, and the base has a base body and a mounting rail, the mounting rail being disposed at the base body, the at least one built-in device being received in an inner space of the base body, and erected on the mounting rail in order for shifting relative to the base body by the mounting rail.

12. The smart street lamp of claim 11, wherein the base further has a door for opening/closing the inner space of the base body, and the smart street lamp further includes a door opening/closing sensing mechanism for sensing an opening/closing state of the door, and reporting a sensing result to a preset object.

13. The smart street lamp of claim 2, wherein the at least one luminaire is a plurality of luminaires.
